(19) United States
(12) Patent Application Publication
(10) Pub. No.: US 2008/0034080 A1
(43) Pub. Date: Feb. 7, 2008

(54) POLICY TRANSLATOR - POLICY CONTROL IN CONVERGENT NETWORKS

(75) Inventors: Sangeetha Chamaraj, Bangalore (IN); Aditya Dhruva, Bangalore (IN); Deepak Sreenivas, Bangalore (IN)

Correspondence Address: BELL, BOYD, & LLOYD LLP, P.O. BOX 1135, CHICAGO, IL, 60690, US

(73) Assignee: NOKIA SIEMENS NETWORKS GMBH & CO, Munchen (DE)

(21) Appl. No.: 11/833,102

(22) Filed: Aug. 2, 2007

(30) Foreign Application Priority Data
Aug. 2, 2006 (IN) 776/KOL/2006

(51) Int. Cl. G06F 15/173

(52) U.S. Cl. 709/223

(57) ABSTRACT

The invention relates to a policy translator for a telecommunication network. The system includes an interface between the policy translator and a policy repository storing existing policies for one or more telecommunication networks, an interface between the policy translator and one or more gateways over which interface the policy translator can receive from a gateway a request for a policy check (naming a source and destination network, the user and the service requested) and over which interface the policy translator can send a response after evaluating the request (“Permit”, “Permit, but Modify” or “Deny”), an interface between the policy translator and a subscriber database of a telecommunication network, an interface between the policy translator and a charging element for exchanging charging related information.

### CLAIM FOR PRIORITY

This invention claims the benefit of priority to IN 776/KOL/2006, the contents of which are hereby incorporated by reference.

### TECHNICAL FIELD

The invention concerns a policy translator and policy control method.

### BACKGROUND

Convergence is a mechanism for mobile operators and mobile virtual network operators (MVNOs) to expand the reach of their services and applications by making use of already existing broadband IP infrastructure to reach more customers in more places. Multi-network devices allow users to access network services over multiple networks. A gateway element in the carrier's network allows them to deliver their services securely, with mobility within and between networks, and with quality of service assurance.

The era of convergence brings with it many promises as well as challenges. The convergent world will require multivendor, multiprotocol open networks with software systems as the core of intelligence. Networks (as shown exemplarily in FIG. 1) will have to support SS7, IN, ATM, IP, and SIP and anticipate a host of protocols that are yet to come. Functionality must include multimedia call agents, protocol conversion, gatekeepers, applications, billing, provisioning, authentication and network management.

For users, the benefits of convergence include:
Improved coverage in areas in which the wide-area network is weak, such as in-buildings, in underground locations, etc.
Faster access for data sessions (even when the wide area network is available) since local area wireless technologies have more bandwidth available.
Converged devices, so that the user can be reached at any location (home, travel, work) at the same number and, in the event the user is not reached, his messages will all go to the same mailbox.
A cost reduction for using alternative wireless and backhaul networks, rather than operator provided networks.

As compelling as these benefits to the end user are, the benefits to the mobile operator are even more so. Those benefits include:
Offloading traffic from the wide area network, both in terms of offloading the licensed spectrum, and also offloading in many cases the legacy circuit switched network, since voice calls initiated from the IP networks will use VoIP.
Lowering the cost of backhaul, since the traffic will make its way back to the mobile operator's network via backhaul already paid for by the subscriber (ISP and Internet access).
Enhancing the performance of the services both in areas in which the wide area coverage is weak, and in any area when the user wants access to high data rate services.
Integration of wireless and wireline services. Convergence allows mobile operators to enhance their revenues by accelerating the movement of (especially) voice minutes off of the fixed networks and onto the mobile networks.

True convergence has eluded the world of telecommunications for decades. Until this last decade, the ability to run voice on data networks has not even existed. Though recent advances in technology have allowed voice services to be delivered over digital subscriber line (DSL) using the Class-5 switch/GR303 model, the resulting services are still completely unaware of personal computers (PCs) running voice-over-Internet protocol (VoIP) applications such as NetMeeting or IP phones from companies such as 3Com. And there are still two networks—one for data (and its terminals) and one for voice (and its terminals).

In a converged network environment, a user's voice network should work in the same manner as his or her data network. A recent confluence of events is finally making possible such applications that represent true convergence. Intelligent user phones, terminals, and IP-based gateways are coming to market, sporting industry-standard call-control protocol stacks, such as SIP and MGCP. They make it possible for competitive carriers to offer not only next-generation services that literally are not possible in the existing PSTN but also new interpretations of existing custom local-area signaling services (CLASS).

Issues with Convergence are:

In a convergent network, each network domain has its own protocol for signaling, resource reservation and bearer traffic. These protocols are valid only within the respective domain boundary. The networks are different not only physically but also in operational aspects. Moreover the Quality of Service (QoS) is different in each of the network. This diversification causes some problematic scenarios which hampers the efficient working of the convergence.
1. When information needs to be passed across the boundary, the information in one domain may be meaningless to the other domain. In such a scenario it is required to translate the protocol information accordingly. This is done in the gateway, which is the network element between the two domains. The gateway does the conversion as defined by mapping rules between the two protocols. But the main issue here is that the gateway does not perform any check to see whether the protocol conversion performed is actually valid. This means the gateway just translates the parameters and passes the signaling messages without any explicit check whether the requested resources can be granted. Since the gateway does not know the total existing resources, the resources granted and resources remaining, it is not possible to reject requests at this stage. These requests which are expected to fail are unnecessarily transmitted till the end user. This leads to unnecessary network congestion.
2. Admission control is performed only at the end in the customer's premises. This leads to inefficiency in the network and also possible pilferage.
3. Since many networking domains converge, it is increasingly difficult to collect the statistics and bill the customer. There is very limited support for the concept of “single bill” in a convergent network.

### SUMMARY

The invention supports policy control in a convergent network. The policy translator element according to the invention allows efficient support of policy control in a convergent network. Additional features and advantages are described herein, and will be apparent from, the following Detailed Description and the figures.

### BRIEF DESCRIPTION OF THE FIGURES

Further details and advantages of the invention are set forth in the following description, wherein in the enclosed drawing:

FIG. 1 shows a network convergence architecture.

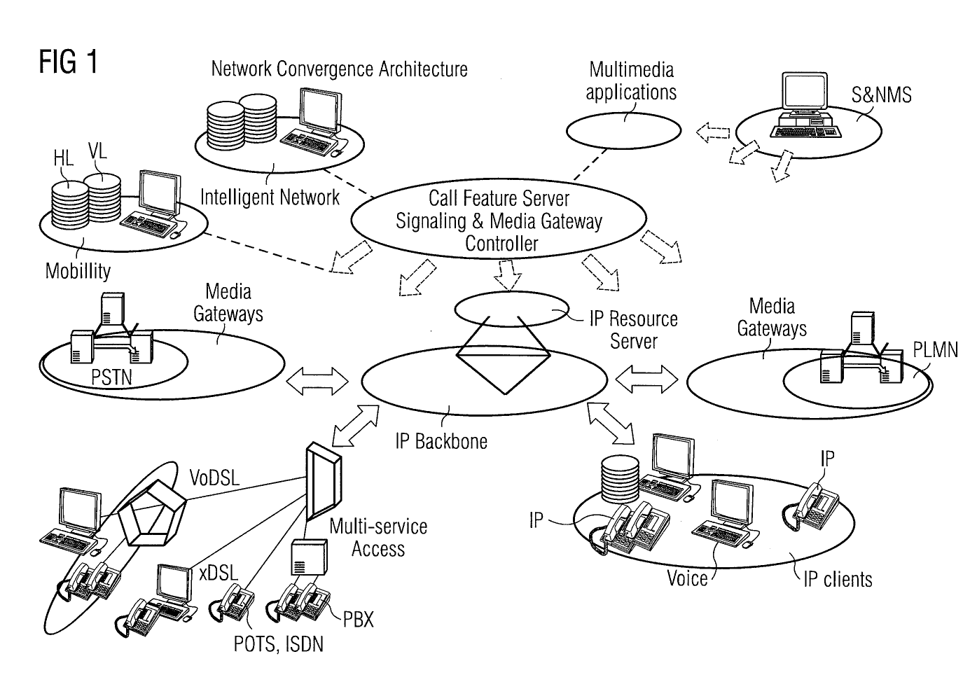

FIG. 2 shows a policy translator in an overall network.

FIG. 3 shows a message flow.

FIG. 4 shows consolidation of billing information.

FIG. 5 shows a translation of configuration information from SLA.

### DETAILED DESCRIPTION

A solution to current deficiencies includes a centralized monitoring and authorizing entity between the edges of the different domains of the IMS network to address the problems raised above. This central entity can play the following roles (but not limited to):
1. E2E Resource Management: This central entity keeps track of the total resources consumed end-to-end i.e. between the user and application end points. For e.g. the user may be a mobile phone playing a video stream and the application end point may be a streaming video server. For every Video on demand user, the bandwidth between the video server and the gateway gets reduced accordingly. Also the central entity would know the number of users on one end. When the maximum limit is reached, the further requests for video are blocked by this central entity.
2. Border Admission Control: Admission control functionality for security can also be performed at the central entity in the boundary of the two networks.
3. Centralizing Billing: Billing can be centralized in the same entity. This entity would contain the mapping of all parameters of the disjoint domains. This would generate a common set of quantifiable metrics from the collected domain specific metrics.

This multifunctional central monitoring and authorizing entity is the Policy Translator. The next section covers the features of Policy Translator in more depth.

### Policy Translators: Policy Control in Convergent Networks

Currently the gateway element of each domain converts parameters to the format of the bordering domain(s). In this kind of a convergent network, the Policy Translator can apply policies across network domains at their borders.

The Policy Translator can be a Policy Decision Point (PDP) with respect to each of the Gateway elements that it interfaces, and the Gateway in turn would be the Policy Enforcement Point (PEP) in the network. This enables an operator to define policies applicable across networks and also ensure that services and bandwidth are granted based on the existing policy.

The Policy Translator also interfaces with the subscriber database to retrieve policies relevant to a particular subscriber and reject requests for which the subscriber does not have access.

The Policy Translator interfaces with the Customer Care Center/Management Center to evaluate whether the requests can be successfully handled in the destination networks. This allows for pre-emptive fault handling in Convergent Networks at the border itself avoiding unnecessary signaling and traffic in the networks.

Finally the requests to the Policy translator are consolidated and sent to the charging center where a bill is created for each subscriber based on the QoS usage across the network domains.

### Position in the Network

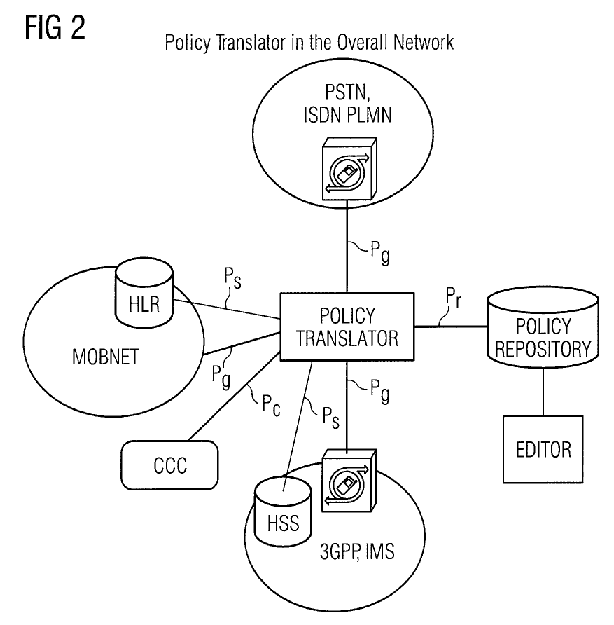

FIG. 2 shows a Policy Translator in the Overall Network The figure shows the overall network hierarchy including the Policy translator and its various interfaces. The interfaces are explained below:

### Pr—Between the Policy Translator and the Policy Repository

This interface will define the interactions between the Policy Translator and the Policy Repository. It should enable the Policy Translator to retrieve all existing policies using a “Pull” model. Also the Policy Repository should be able to “Push” the new/updated policies onto the Policy Translator. This interface could be over the HTTP/XML/SOAP technology. As part of a distributed architecture, this Policy Repository could also be merged with the Subscriber Databases (HLR, HSS) and thus there would be a single point for storing the policies and the subscriber related data.

### Pg—Between the Policy Translator and the Gateway

This interface will define the interactions between the Policy Translator and the Gateway. The gateway should be able to send a request for a policy check including the source and destination network, the user and the service requested. The Policy Translator in turn should be able to send the response after evaluating the request to the Gateway. This response would also include the parameters to be defined on the destination network. This interface could be over the COPS/Diameter protocol. The actual response returned may “Permit”, “Permit, but Modify” or “Deny” the request based on the policies applicable. Thus this interface would help in reducing the traffic across gateways as a request with a “Deny” decision is rejected at the boundary itself. The Policy Translator could also indicate if the destination gateway is overloaded, unable to process requests currently and hence instruct the source gateway to resend the request at a later time.

### Ps—Between the Policy Translator and the Subscriber Database

This interface will define the interactions between the Policy Translator and subscriber database. This interface could be over the HTTP/XML/SOAP technology or any new Provisioning interface suitable for retrieval of user data from the Subscriber Database. The Policy Translator will be able to check if a user is allowed to avail a particular service or not based on his credentials and also his usage patterns and limits. In the extreme case, the Policy Translator will be able to instruct the Subscriber Database (e.g. HSS, HLR) to block services to a particular subscriber, when his usage goes beyond limits, or if malicious usage is detected.

### Pc—Between the Policy Translator and the CCC

This interface will define the interactions between the Policy Translator and CCC. All charging related information will be exchanged via this interface. This interface could be over Radius. The Policy Translator could inform the CCC for every request received, or it could consolidate the requests related to a subscriber and send them at regular intervals. This interface is also used by the Policy Translator to understand the health of the bordering networks and take appropriate actions during call flow. Typically this would be by cooperating with the Fault & Performance Management interfaces of the CCC.

### Policy Matrix

Consider three networks Network 1, 2 and 3 and Policies A, B, C, D, E and F. The table below shows a possible configuration of policies as applied between networks.

TABLE 1
Sample Policy Matrix

Destination

| Source | Network 1 | Network 2 | Network 3 |
|---|---|---|---|
| Network 1 | | Policy A | Policy A |
| | | Policy B | Policy C |
| Network 2 | Policy B | | Policy D |
| | Policy E | | |
| Network 3 | Policy C | Policy B | |

In the sample policy matrix shown above, the operator has configured Policy A and B as applicable to a request from the source Network 1 to destination Network 2. The Policy translator would hence apply Policy A and B on the request.

The result of this evaluation would determine if the request is accepted or rejected.

The outcome of a request to the Policy Translator by one of the gateways could be any of the following
The applied policies “permit” the service to flow across the border or “deny it”
The applied policies indicate the set of conversions to be done for a permitted service
The applied policies indicate a reduction in QoS levels to allow for the request to be served (without, which it may not be possible to service the request)

The above scenarios are just a sample and there may be many more such scenarios in practice.

### Sample Message Flow

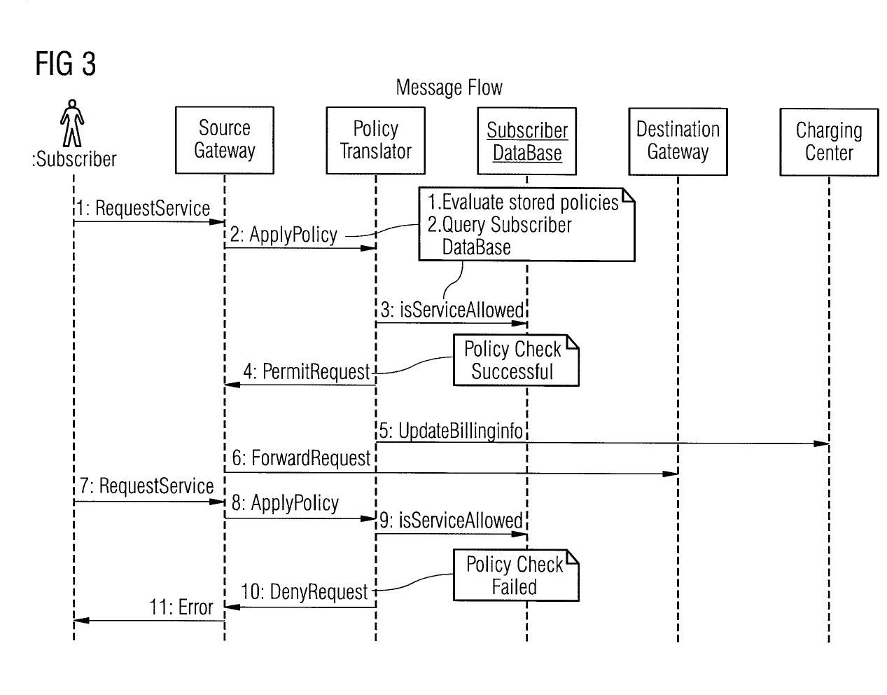

FIG. 3 shows a sample message flow.
1. Each gateway element queries the Policy Translator on the receipt of a message from a source network to a destination network.
2. It sends the source and the destination network to the Policy Translator for applying the policy. The Policy Translator maps the source with the destination network to find the policies that are applicable.
3. The Policy Translator would also interface with the subscriber databases to check if the service being requested from the Destination network is permissible.
4. It then evaluates the policies and sends the result back to the requesting gateway.
   a. The result would be a “Permit” with the parameters applicable to the destination network
   b. The result would be a “Deny” if the policy check fails.
5. If the request is permitted the charging center is informed of the QoS usage granted and the service requested.
6. The Gateway would forward the request to the destination gateway or return an error based on the result of the policy evaluation.

### Use Cases

### QOS Control

The use case is based on a network Quality of Service (QoS) management. QoS management in communication networks requires that administrators be able to manage the network devices and infrastructure in such a way that predictable performance is achieved. One of the mechanisms proposed for achieving this is the Differentiated Services (DiffServ) architecture which aggregates network traffic into defined classes of service, and configures the routers in the network to treat each of these classes in the appropriate manner. This results in a network where, at each hop, a packet might be handled differently based on the DiffServ class it has been assigned to. Policy Translator provides the ability to dynamically configure a system, by separating the rules that govern a system's behavior from the functionality supported by it. Policies can be specified, and applied to large numbers of devices uniformly. In the case of the DiffServ architecture, policies could be used to dynamically reconfigure the routers in the network, such that the desired QoS goals are achieved; and also to perform admission control, deciding on which traffic flows to accept into a network.

Such dynamic configurations require policy translation between two technologies. In fact, the operators SLA needs to percolate seamlessly into the different network elements. The Policy Translator ensures applicability of the operators SLA between network domains. Hence it provides a single point to ensure QoS across network boundaries.

### Single Bill

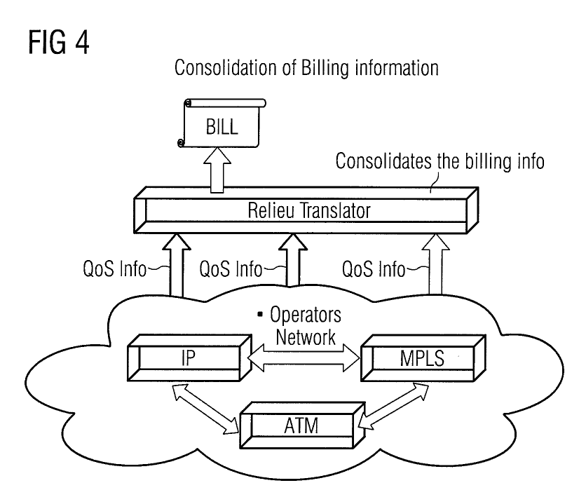

FIG. 4 shows a consolidation of billing information. In the traditional billing model switches generate multiple transactions based upon the type of call the customer placed. These transactions are correlated and packaged into a single Call Detail Record (CDR) at the end of the service instance for billing purposes. Here services and awareness of “call state” is usually maintained in one or at most two nodes of the network, which makes such correlation relatively straightforward.

Due to convergence, however, there is a flood of statistical information from different network elements which the operator has to consider for the purpose of billing. Also it becomes very cumbersome if the customer receives different bills for each network usage.

The policy translator solves this issue by consolidating the statistics across domains and translating them to single statistical information for billing purpose forwards the same to the Charging interface. This is possible because the Policy Translator keeps up-to-date information on the QoS allocated per subscriber in each network. This consolidated view is pushed towards the CCC allowing for a significantly easier approach to “Billing based on Usage”.

### Single Configuration Window

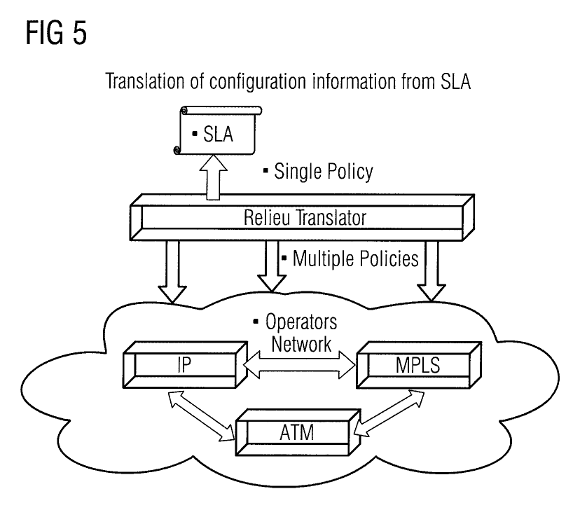

FIG. 5 shows a translation of configuration information from SLA. The Policy Translator can provide a convenient medium for the Operator to configure the inter-working between networks in a convergent domain. The operator would have to specify the Service Lease Agreements/Roaming Agreements and the Policy Translator would convert it into policies applicable at each of the bordering networks. Thus the policy server percolates the SLA to the minutest detail, thus ensuring end to end adherence of the SLA.

Sample Policies:
1. If the sum of the bandwidth of active sessions for a subscriber from the 3GPP to the MOBNET domain exceeds the limit, then reject the request.
   Here, a subscriber's bandwidth limit between 2 domains is limited.
2. If the available sum of the bandwidth of active sessions for a subscriber from a particular domain exceeds the limit then reject the request.
   Here, a subscriber's bandwidth on a single domain is limited.
3. If the bandwidth available to a subscriber on a particular domain is sufficient to satisfy the audio requirement only (for ex: 128 kbps), then permit the audio and reject the video.
   Here, a subscriber is given access at least to audio, incase he does not have sufficient bandwidth available for both audio and video.
4. If the total number of simultaneous requests by a subscriber for a particular service is exceeded, reject the request.
   Here, the number of requests that a subscriber can make for a particular service is limited.
5. If the destination domain is blacklisted for a subscriber, reject the request.
   Here, a subscriber is not allowed to access a particular domain if the domain is in his “list of blacklisted domains”.

The Policy Translator holds great promise towards the commercial success of Convergent Networks, especially the Fixed Mobile Convergence (FMC) solutions of Siemens. In this regard, the architecture for the Policy Translation is also quite future-proof because it fits neatly into the distributed architecture envisaged for Mobile Core networks. The Policy Repository is hosted on the Central Network Database and the Policy Translator works similar to other Network Front-Ends.

The challenge for the future also lies in the fact that a robust and efficient Policy Matrix must be prepared in order to satisfy the needs of the QoS Control across domains. This will depend on the dynamic of the operator networks and the type of services that the operator will offer.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A policy translator for a telecommunication network, comprising:
a first interface between the policy translator and a policy repository storing existing policies for one or more telecommunication networks;
a second interface between the policy translator and one or more gateways for receiving a request for a policy check over a gateway interface from a gateway and for sending a response to the gateway.

2. The policy translator according to claim 1, further comprising a third interface between the policy translator and a subscriber database of a telecommunication network,

3. The policy translator according to claim 2, further comprising a fourth interface between the policy translator and a charging element for exchanging charging related information.

4. The policy translator according claim 1, wherein the request for a policy check comprises an indication of a source telecommunication network and a destination telecommunication network, a user and the service requested.

5. The policy translator according to claim 1, wherein a response of the policy translator after evaluating a request is a permission for a policy, a permission for a policy with modifications or a denial.

6. The policy translator according to claim 1, wherein the policy translator is a policy decision point with respect to the gateway elements that it interfaces.

7. The policy translator according to claim 1, wherein the policy translator provides support for elimination of north-bound interfaces across all layers of a telecommunication network.

8. The policy translator according to claim 1, wherein the policy translator uses data co-located in the policy repository for network management.

9. The policy translator according to claim 1, wherein a Unified Logical Data Model covers layers of network management including management data in network elements.

10. The policy translator according to claim 1, wherein for stateless or data-less management applications data is decoupled from management applications.

11. The policy translator according to claim 1, wherein the policy translator is configured to support data centric management applications.

12. The policy translator according to claim 1, further comprising an end-to-end resource management function keeping track of the total resources consumed between a user and application end points.

13. The policy translator according to claim 1, further comprising a Border Admission Control function for security.

14. The policy translator according to claim 1, further comprising a central billing function including a mapping of parameters of disjoint domains of the one or more telecommunication for generating a common set of quantifiable metrics from the collected domain specific metrics.

15. A method for policy control in convergent networks, having a policy translator, comprising:
receiving information regarding existing policies for one or more telecommunication networks over an interface between the policy translator and a policy repository storing existing policies for one or more telecommunication networks,
receiving a request for a policy check at the policy translator from a gateway, via an interface between the policy translator and one or more gateways, and
sending a response from the policy translator via the interface after evaluating the request.
